(19) United States
(12) Patent Application Publication
(10) Pub. No.: US 2015/0235294 A1
(43) Pub. Date: Aug. 20, 2015

(54) NETWORK SEARCHING SYSTEM AND SEARCHING METHOD THEREOF

(71) Applicant: Mogan Global Online Shopping Inc., Zhubei City (TW)

(72) Inventor: Shih-Chien Chang, Zhubei City (TW)

(73) Assignee: Mogan Global Online Shopping Inc., Zhubei City (TW)

(21) Appl. No.: 14/185,363

(22) Filed: Feb. 20, 2014

(51) Int. Cl. G06Q 30/06; G06F 3/0483; G06F 17/28; G06F 17/30

(52) U.S. Cl. CPC G06Q 30/0625; G06F 17/30867; G06F 3/0483; G06F 17/289; G06F 17/2845

(57) ABSTRACT

A network searching system and a network searching method thereof are disclosed. The network searching system includes a plurality of servers and a searching host. Each of the servers includes a searching engine and stores at least one piece of merchandise information. The servers search the merchandise information therein via the respective searching engines. The searching host electrically connects to each of the servers. The searching host stores a retrieval program and a retrieval interface. The searching host imports the merchandise information respectively from the servers via the retrieval program and displays the merchandise information on the retrieval interface. Besides, the searching host receives a searching string and searches the merchandise information imported from the servers according to the searching string, generates the merchandise information matching the criterion of the searching string, and displays such merchandise information on the retrieval interface.

### BACKGROUND OF THE INVENTION

1. Field of the Invention

This disclosure relates to a searching system and the searching method thereof and, more particularly, to a network searching system applicable to integrating a plurality of online shopping platforms and the network searching method thereof.

2. Description of the Related Art

With the improvement of online trading and the digital technology, online shopping has become the biggest trading media for the younger generation. Meanwhile, owing to the development of online cash flow and merchandise flow, the categories of merchandise at each online shopping platform extend to a variety of fields, such as clothing, traveling, and entertainment. The market coverage for online trading is not limited to one single country or an area. Anyone can use the Internet to connect to any online shopping platform in any country to access immediate merchandise information or to sell or buy specific merchandise of a country.

However, users who are not good at the language used in the country where the users wants to use the online shopping platform or not familiar with the culture of the online shopping of the country cannot find the popular online shopping platforms of the country easily. In addition, it is difficult for users to get access to the online shopping platforms which sell specific categories of merchandise. More importantly, even though users can find specific foreign online shopping platforms, it is difficult for them to quickly locate the merchandise they want or to understand the merchandise information shown on the websites due to limitation on the foreign language. Hence, it is likely that the users may purchase unsatisfying merchandise, and, worse yet, trade disputes may occur, which may adversely reduce the users' intentions to purchase merchandise across countries.

Therefore, how to integrate multiple online shopping platforms across countries and how to provide users assistance while searching merchandise or reading information of the merchandise inevitably become problems for many online shopping companies or multinational companies shopping for the users.

### SUMMARY OF THE INVENTION

In view of the problems described above, this disclosure provides a network searching system which can integrate a plurality of online shopping platforms and a network searching method thereof. The network searching system and the method thereof solve the problem that users are not able to easily access online shopping platforms of each country, and the problem that users are not familiar with the language of the country, and thus the users are not able to search the merchandise or read the merchandise information on the online shopping platforms of the country.

The network searching system disclosed includes a plurality of servers and a searching host. Each of the servers includes a searching engine and stores at least one piece of merchandise information. Each of the servers searches the merchandise information through the corresponding searching engine. The searching host electrically connects to each of the servers respectively and stores a retrieval program and a retrieval interface. The searching host imports the merchandise information from each of the servers respectively via the retrieval program and displays the imported merchandise information on the retrieval interface. On receiving a searching string, the searching host searches the merchandise information imported from each of the servers according to the searching string via the retrieval program, generates the merchandise information matching the criterion of the searching string, and displays the matched merchandise information on the retrieval interface.

This disclosure further provides a network searching method applicable to the foregoing network searching system. The method includes the steps, to be performed by the searching host, of: importing at least one piece of merchandise information stored in a plurality of servers respectively via a retrieval program; displaying the merchandise information imported from each of the servers on a retrieval interface via the retrieval program; receiving a searching string; searching the merchandise information imported from each of the servers according to the searching string via the retrieval program; generating the merchandise information matching the criterion of the searching string; and displaying the merchandise information matching the criterion of the searching string on the retrieval interface.

In addition, this disclosure further provides another network searching system. The network searching system includes a plurality of servers and a searching host. Each of the servers separately stores at least one piece of merchandise information and at least one piece of web page information. The web page information is used for displaying the merchandise information stored in the respective server. Each of the servers includes a searching engine and searches the merchandise information stored in the respective server via the searching engine. The searching host electrically connects to each of the servers and stores a retrieval program and a retrieval interface. The searching host connects to each of the servers via the retrieval program and displays the web page information respectively sent from each of the servers on the retrieval interface. The searching host receives a searching string and sends the searching string to each of the servers respectively via the retrieval program. Each of the servers searches the merchandise information stored in the respective server according to the searching string via the searching engine, generates the merchandise information matching the criterion of the searching string, and sends the matched merchandise information back to the searching host. The searching host receives the merchandise information matching the criterion of the searching string from each of the servers respectively and displays the merchandise information matching the criterion of the searching string on the retrieval interface.

This disclosure further provides another network searching method applicable to the foregoing network searching system. The method includes the steps, to be performed by the searching host, of: connecting to a plurality of servers respectively via a retrieval program; receiving a web page information displaying at least one merchandise information sent from each of the servers via the retrieval program and displaying the web page information sent from each of the servers on a retrieval interface; receiving a searching string; sending the searching string to each of the servers respectively via the retrieval program; each of the servers searching the merchandise information stored in the respective server according to the searching string via the searching engine and generating the merchandise information matching the criterion of the searching string and sending the matched merchandise information back to the searching host; and receiving the merchandise information matching the criterion of the searching string from the respective server and displaying the merchandise information matching the criterion of the searching string on the retrieval interface.

Therefore, with the use of the networking searching systems and the networking searching methods in accordance with the present invention, a plurality of online shopping platforms across different countries are able to be unified in the networking searching system through connection of networks or importing of the merchandise information, whereby users are able to browse, search, or trade merchandise through the networking searching system. In addition, with the translating function for searching string and the merchandise information disclosed in accordance with the present invention, users may enter searching string in their native language, and the translating engine with an accompanying database is configured for generating language string corresponding to the searching string to be searched for the merchandise information either via each of the servers or the searching host capable of processing different languages. In this way, users are able to sell or buy merchandise among multiple online shopping platforms across countries by using one single network searching system.

In addition, with the translating function described above, the difficulties of using online shopping across countries can be substantially reduced and thus the users' intention to use such system can be increased. Therefore, the business on multinational online shopping and online shopping for the users can be expanded.

### BRIEF DESCRIPTION OF THE DRAWINGS

The present invention will become more fully understood from the following detailed description of some illustrative embodiments in conjunction with the accompanying drawings, in which:

FIG. 1 is a connection diagram view of the network searching system in accordance with a first embodiment;

FIG. 2 is a flowchart of the network searching method in accordance with the first embodiment;

FIG. 3 is a flowchart of the network searching method with translating function in accordance with the first embodiment;

FIG. 4 is a schematic view of the network searching method in accordance with the first embodiment;

FIG. 5 is a schematic view of the translating function in accordance with the first embodiment;

FIG. 6 is a schematic view of the translation feedback function in accordance with the first embodiment;

FIG. 7 is a schematic view of one displaying way of the network searching method in accordance with the first embodiment;

FIG. 8 is a schematic view of another displaying way of the network searching method in accordance with the first embodiment;

FIG. 9 is a connection diagram view of the network searching system in accordance with a second embodiment;

FIG. 10 is a flowchart of the network searching method with translating function in accordance with the second embodiment;

FIG. 11 is a schematic view of the network searching method in accordance with the second embodiment;

FIG. 12 is a schematic view of the translating function in accordance with the second embodiment;

FIG. 13 is a flowchart of the network searching method in accordance with a third embodiment;

FIG. 14 is a flowchart of the network searching method with translating function in accordance with the third embodiment;

FIG. 15 is a schematic view of one displaying way of the network searching method in accordance with the third embodiment;

FIG. 16 is a schematic view of another displaying way of the network searching method in accordance with the third embodiment; and

FIG. 17 is a flowchart of the network searching method in accordance with a fourth embodiment.

### DETAILED DESCRIPTION OF THE INVENTION

Four embodiments for the network searching system and the network searching method thereof are described as follows. These embodiments, although the hardware configurations, connection types, or steps are varied, are provided so that this disclosure will be thorough and complete and thus will fully convey the scope of the invention to those skilled in the art.

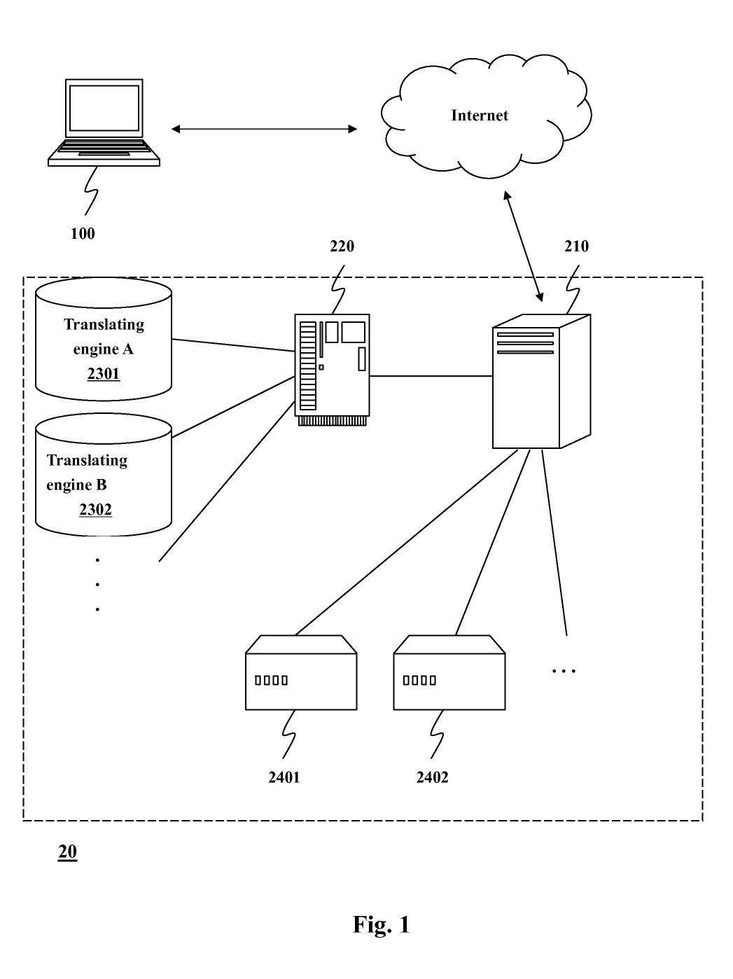

Please refer to FIG. 1 for the first embodiment, where the network searching system 20 includes a searching host 210 and a plurality of servers such as a server 2401, a server 2402, and other servers. The server 2401, the server 2402, and other servers separately store at least one piece of merchandise information and include a searching engine. The server 2401, the server 2402, and other servers search the merchandise information stored in each server via its searching engine respectively. The server 2401, the server 2402, and other servers described herein includes, but not limited to, website programs for constructing and storing various online shopping platforms of different countries and server hosts for displaying shopping information at the online shopping platforms. This type of servers is not limited to the same country or the same category of merchandise sale. For example, the server 2401 may belong to an “A” online shopping platform of Taiwan. The server 2402 may be a “B” online shopping platform for selling golf gears and belong to Japan. Those skilled in the art, without departing from the spirit of the present invention, can take different platforms or different countries into the categories of the servers for different sales needs.

The searching host 210 of the network searching system 20 electrically connects to the server 2401, the server 2402, and other servers respectively. Furthermore, the searching host 210 stores a retrieval program and a retrieval interface. In the first embodiment, the searching host 210 imports the merchandise information respectively from the server 2401, server 2402, and other servers during the construction of the network searching system 20 and displays the imported merchandise information on the retrieval interface.

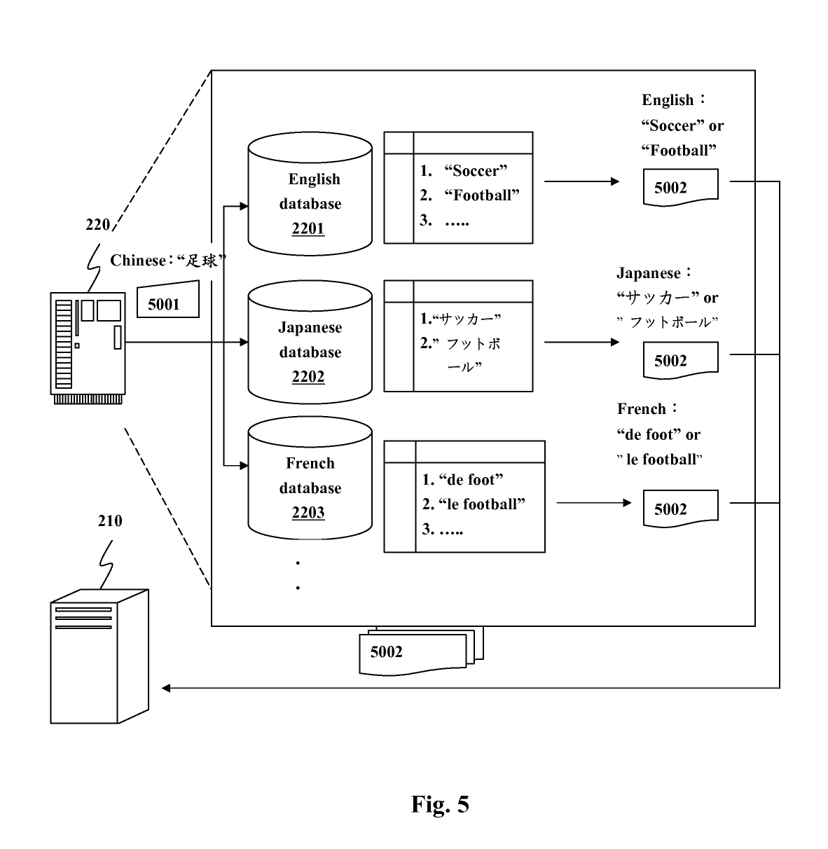

Besides, please further refer to FIG. 5 with continued reference to FIG. 1, in order to add the translating function for the merchandise information and the searching string, in the first embodiment, the network searching system 20 further includes a vocabulary database 220 and a plurality of translating engines such as a translating engine A 2301, a translating engine B 2302, and other translating engines. The vocabulary database 220 stores a plurality of vocabulary information in different language types and corresponding to a first language. Take the network searching system 20 for Chinese users as an example. The first language is Chinese. The vocabulary database 220 stores other vocabulary information corresponding to Chinese and according to the country of the server. If the server 2401 is an online shopping platform belonging to Japan, and the server 2402 is an online shopping platform belonging to French, then the vocabulary database 220 stores database with different vocabulary information, such as English database 2201 for Chinese to English, Japanese database 2202 for Chinese to Japanese and French database 2203 for Chinese to French. In addition, the translating engine A 2301, the translating engine B 2302, and other translating engines support translating functions in different language types with reference to the vocabulary database 220. For example, the translating engine A 2301 supports translation for Chinese to Japanese, and the translating engine B 2302 supports translation for Chinese to French. The detailed translation flowchart will be described in the following description. It is worth noting that the number and the disposition of the server 2401, the server 2402, and other servers and the translating engine A 2301, the translating engine B 2302, and others should not be limited to the first embodiment set forth herein, and thus those skilled in the art can change and adjust the number and the disposition of the servers for different needs.

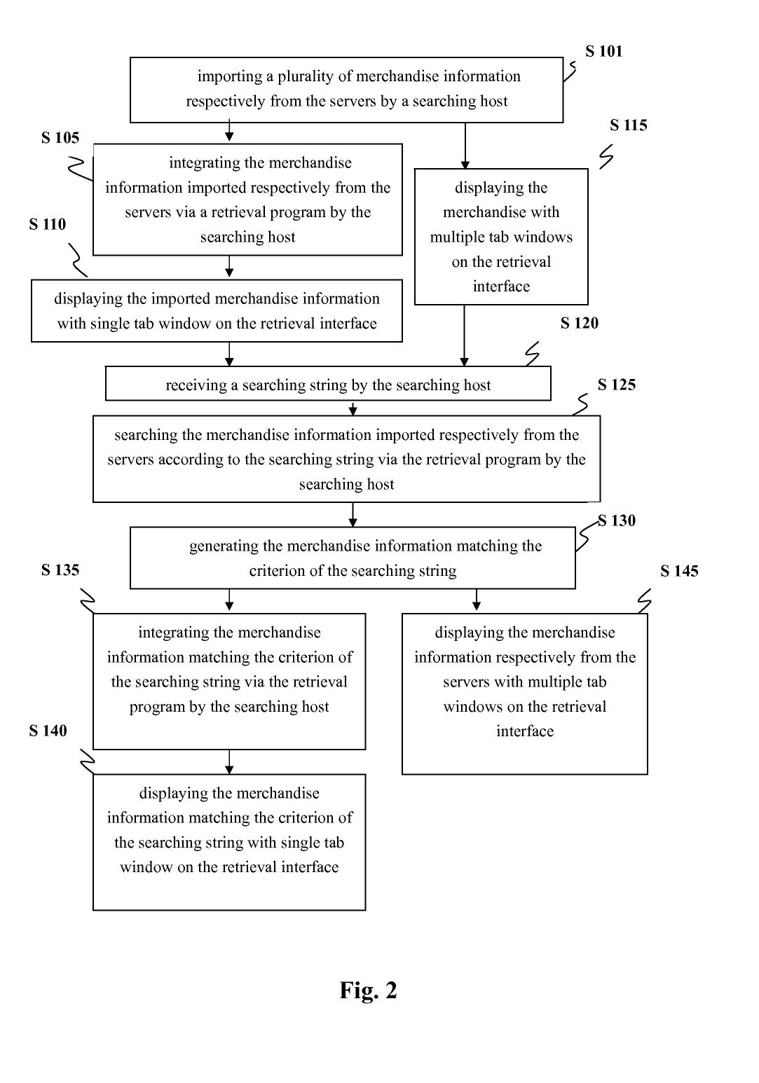

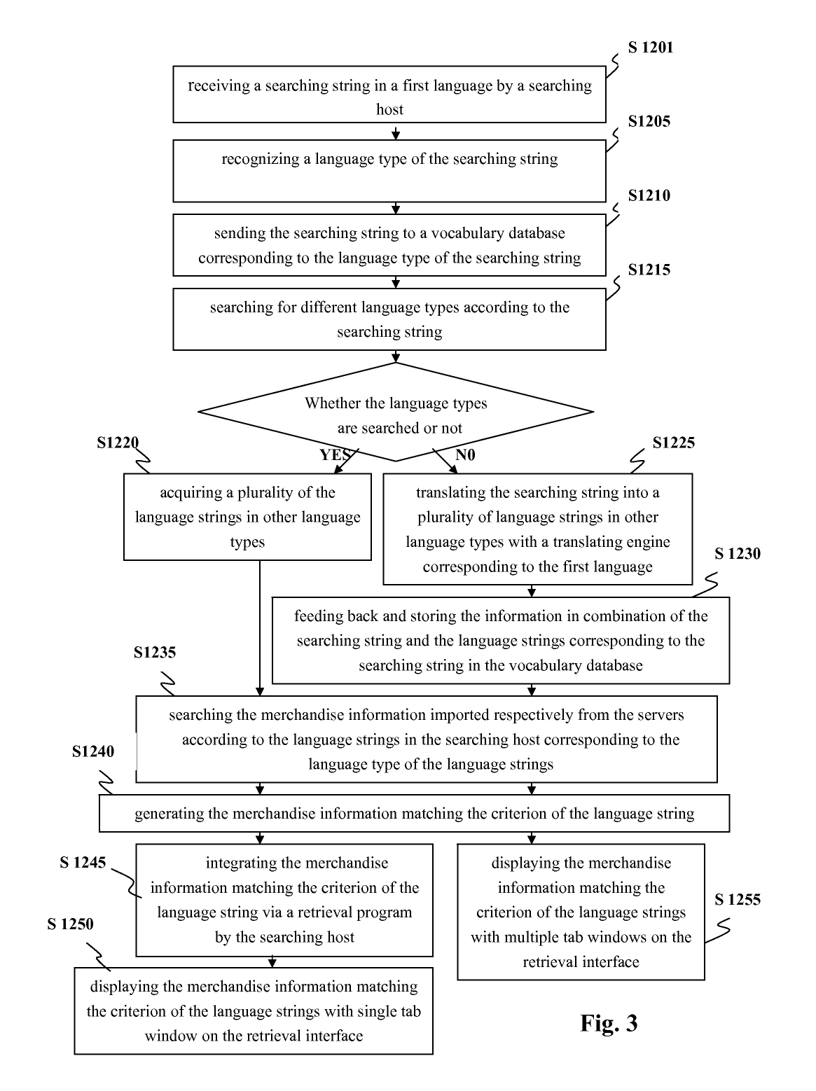

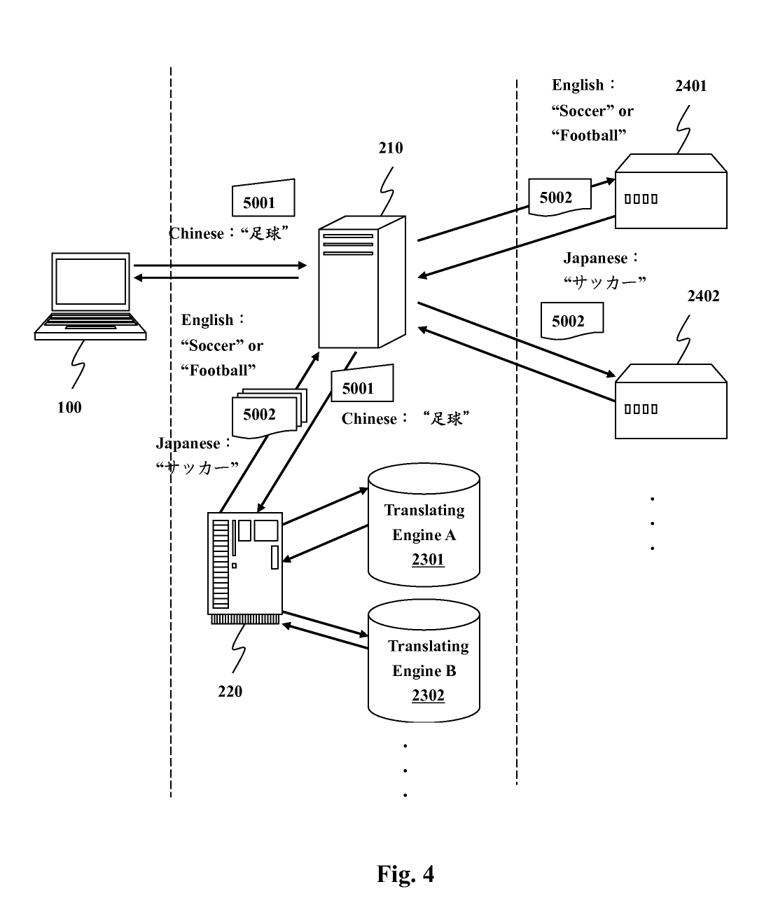

Please further refer to FIG. 2, FIG. 3, and FIG. 4 with continued reference to FIG. 1, the network searching method in accordance with the first embodiment is applicable to the foregoing network searching system 20. Please refer to FIG. 2, firstly, during the construction of the network searching system 20, the searching host 210 imports a plurality of merchandise information respectively from the server 2401, the server 2402, and other servers via the retrieval program (as shown in the step S101). It is worth noting that in the step S101, the searching host 210 can imports all the merchandise information respectively from the server 2401, the server 2402, and other servers into the searching host 210, or, according to a screening criterion, the searching host 210 can import the selective merchandise information respectively from the server 2401, the server 2402, and other servers into the searching host 210. For example, the screening criterion can be set as the criterion relating to golf gears in the searching host 210. Therefore, the merchandise information imported respectively from the server 2401, the server 2402, and other servers will be related to golf gears or contains keywords related to golf gears. After receiving the merchandise information imported respectively from the server 2401, the server 2402 and, other servers, the searching host 210 may display the merchandise information in different ways. In one displaying way, the searching host 210 integrates the merchandise information imported respectively from the server 2401, the server 2402, and other servers via the retrieval program (as shown in the step S105) and displays the imported merchandise information with a single tab window on the retrieval interface (as shown in the step S110). In other words, the searching host 210 integrates the merchandise information imported from the server 2401, the server 2402, and other servers and displays the imported merchandise information with only one tab window on the retrieval interface and marks the imported merchandise information with the server from which the merchandise information is imported. In another displaying way, the searching host 210 displays the merchandise information imported respectively from the server 2401, the server 2402, and other servers with multiple tab windows (as shown in the step S115) on the retrieval interface. In other words, the searching host 210 displays the merchandise information imported from the server 2401 with the first tab window, the merchandise information imported from the server 2402 with the second tab window, and other merchandise information imported from other servers with other tab windows respectively on the retrieval interface.

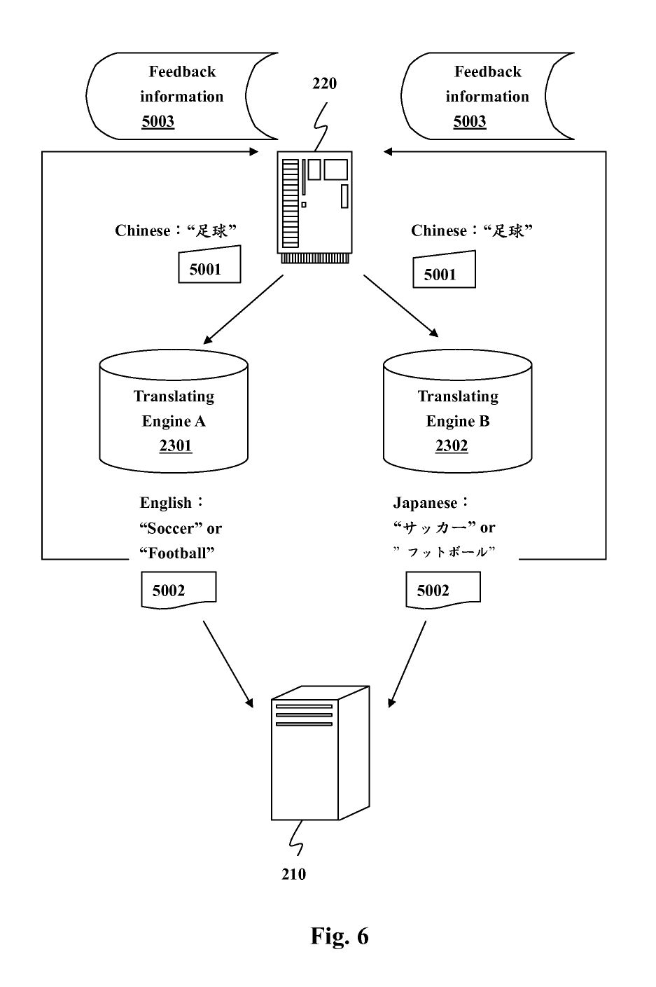

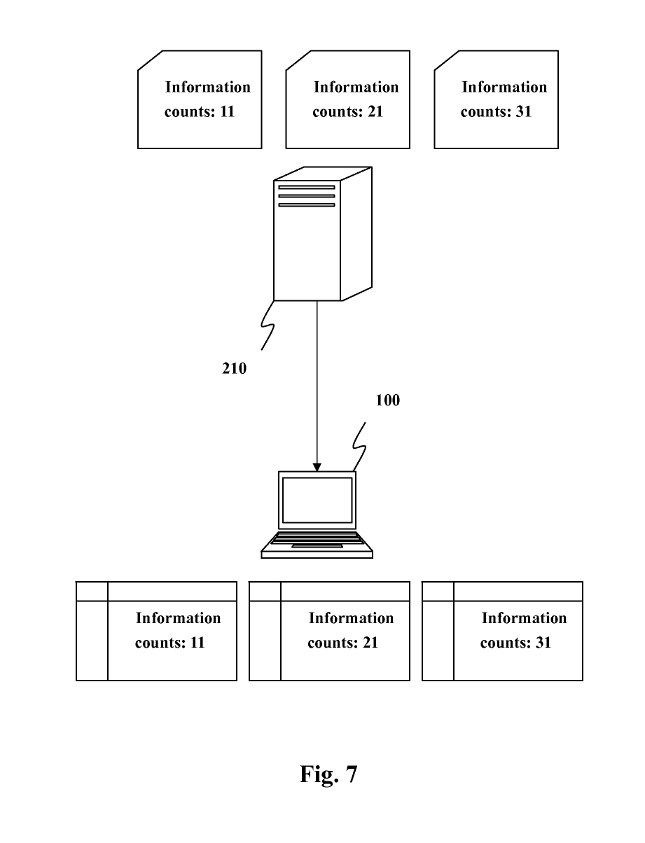

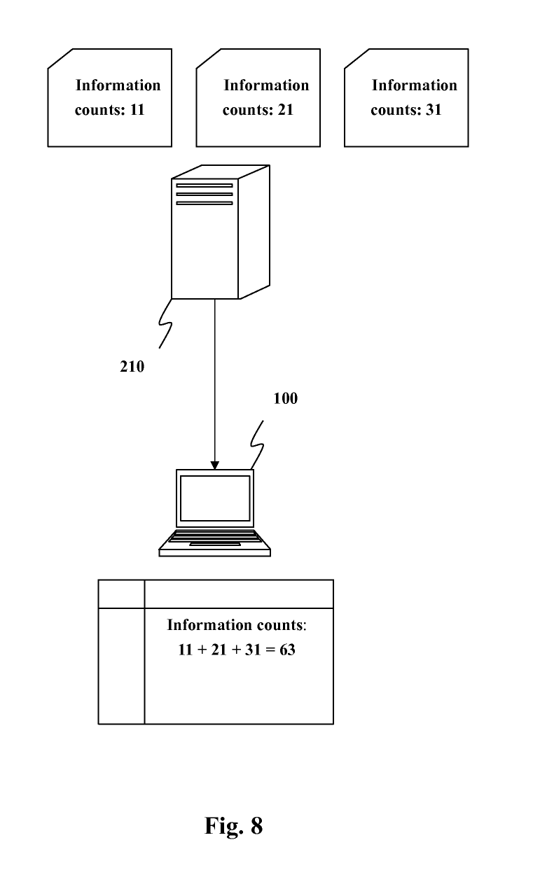

As described above, please further refer to FIG. 4 to FIG. 8 with continued reference to FIG. 1 to FIG. 3 as well, when users search the merchandise via a connection from the client computer 100 to the platform configured by the searching host 210, the searching host 210 receives a searching string sent from the client computer 100 (as shown in the step S120 of FIG. 2) and designates which merchandise information of the server should be searched. For example, if the language types of the server 2401, server 2402 and, other servers designated by the users are the same as the language type of the searching string entered by users, the searching host 210 is able to search the merchandise information stored respectively in the designated server 2401, server 2402, and other servers directly without translating the searching string. Then, the searching host 210 is able to search the merchandise information respectively imported from the server 2401, the server 2402, and other servers directly via the retrieval program according to the searching string (as shown in the step S125) and generate the merchandise information matching the criterion of the searching string (as shown in the step 130). Because the merchandise information has already been imported into the searching host 210, there is no need to connect the searching host 210 to the server 2401, the server 2402, and other servers during the searching process. In addition, after the searching host 210 finishes searching the merchandise information, the searching host 210 displays the merchandise information, in such a displaying way aforementioned, on the retrieval interface. As described above, the merchandise information matching the criterion of the searching string can be integrated (as shown in the step S135) and be displayed on the retrieval interface with a single tab window (as shown in the step S140 and in FIG. 8). It is optionally to display the merchandise information matching the criterion of the searching string with multiple tab windows on the retrieval interface respectively (as shown in the step S145 and in FIG. 7). Two different displaying ways for displaying the merchandise information matching the criterion of the searching string from each of the server 2401, the server 2402, and other servers are provided for users to browse and purchase matched merchandise.

However, please refer to FIG. 3 to FIG. 4 with continued reference to FIG. 1 and FIG. 2 as well, under the circumstance that the language type of the server 2401, 2402, and others designated by users is different from the language type of the searching string entered by the users. After the searching host 210 receives a searching string 5001 in first language such as Chinese (as shown in the step S1201 in FIG. 3), the searching host 210 recognizes the language type of the searching string 5001 via the retrieval program (as shown in the step S1205) and sends the searching string 5001 to the vocabulary database 220 corresponding to the language type (as shown in the step S1210). The vocabulary database 220 searches for different language types according to the searching string 5001 (as shown in the step S1215). If the translated language corresponding to the searching string 5001 are found via the vocabulary database 220, then the vocabulary database 220 acquires a plurality of language strings 5002 in different language types but not in first language (as shown in the step S1220). The language strings 5002 described corresponds to the specific language type of the server 2401, server 2402, and other servers respectively. For example, the searching string 5001 is in Chinese “ [symbol] ” and the server 2401 is a online shopping platform whose main language is English. The language strings 5002 corresponding to the Chinese “ [symbol] ” in English is “Soccer” or “Football”. The server 2402 is an online shopping center whose main language is Japanese. The language strings 5002 corresponding to the Chinese “ [symbol] ” in Japanese is “ [symbol] .” On the other hand, if the vocabulary database 220 is unable to acquire the language strings via the vocabulary database 220 aforementioned, as shown in FIG. 5, the vocabulary database 220 translates the searching string 5001 into a plurality of language strings 5002 in different language types but not in first language via a plurality of translating engines corresponding to the first language such as translating engine A2301, the translating engine B 2302 (as shown in the step S1225) and sends the language strings 5002 to the searching host 210. In addition, the translating engines separately feedback and store the feedback information 5003 in combination of the searching string 5001 and language strings 5002 corresponding to the searching string 5001 in the vocabulary database 220 (as shown in step S1230). With the foregoing translation mechanism, even there is no vocabulary information corresponding to the searching string 5001 in the vocabulary database 220, the translating engines 2301, the translating engines 2302, and others for translating different language types can still acquire the language strings 5002 corresponding to the searching string 5001 and feedback and store the feedback information 5003 in combination of the searching string 5001 received this time and the language strings 5002 corresponding to the searching string 5001 in the vocabulary database 220 so as for the vocabulary database 220 to expand the vocabulary information. Hence, when the translation of the searching string 5001 is needed, the vocabulary database 220 is able to quickly find the language strings 5002 corresponding the searching string 5001, thereby improving the translating function.

As described above, after the searching host 210 acquires the language strings 5002 corresponding to the searching string 5001 by the mechanism mentioned above, the search host 210 searches the merchandise information according to the language strings 5002. The searching process is similar to the searching process without translation as described above. Therefore, please refer to FIG. 2 and the related description, the steps of searching the server 2401, the server 2402, and other servers in the searching host 210 corresponding to the language type according to the language strings 5002, the step of importing the merchandise information, and the step of displaying the merchandise information matching the criterion of the language strings 5002 on the retrieval interface (as shown in the steps S1235 to S1255) are the same as the steps S120 to S145 as shown in FIG. 2. The details are not described herein.

With the steps described above, the searching host 210 integrates the merchandise information from the respective server for users to browse and purchase the matched merchandise. There is no need for the users to connect their computer or electrical device to different online shopping platforms corresponding to the respective servers across countries by themselves, but simply to connect their computer or electrical device to the platform of the searching host 210 for reading the latest and complete merchandise information from different online shopping platforms corresponding to the respective servers across countries. Besides, with the translating function, even though the searching host 210 in the first embodiment receives the searching string 5001 in different language types, the searching host 210 can translate the searching string 5001 into the language strings 5002, through the translating mechanism described above, and perform searching for different needs. In this way, users can enter the language they are familiar with to search merchandise information with the support from the translating function, and thus the difficulties and doorsill of multinational online shopping can be lowered so as to increase the intention of purchase from users.

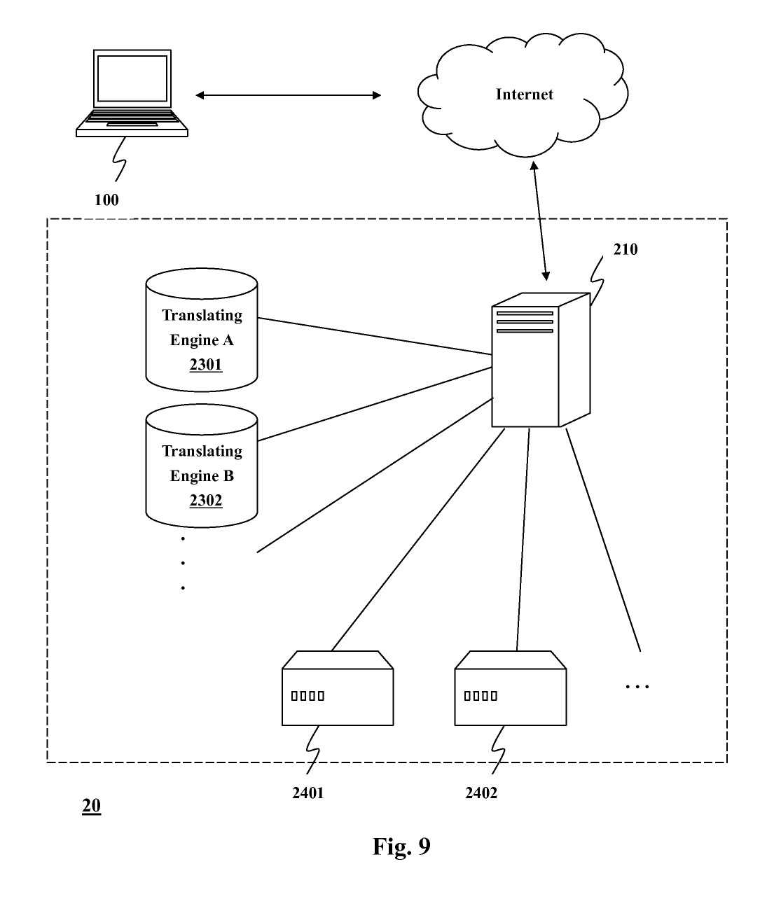

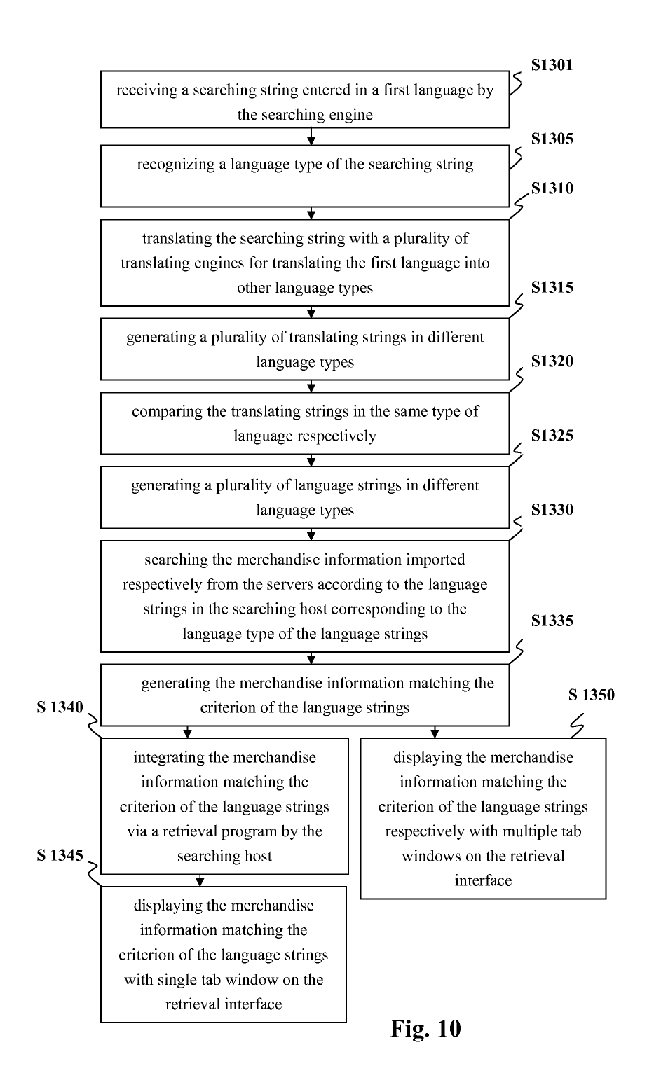

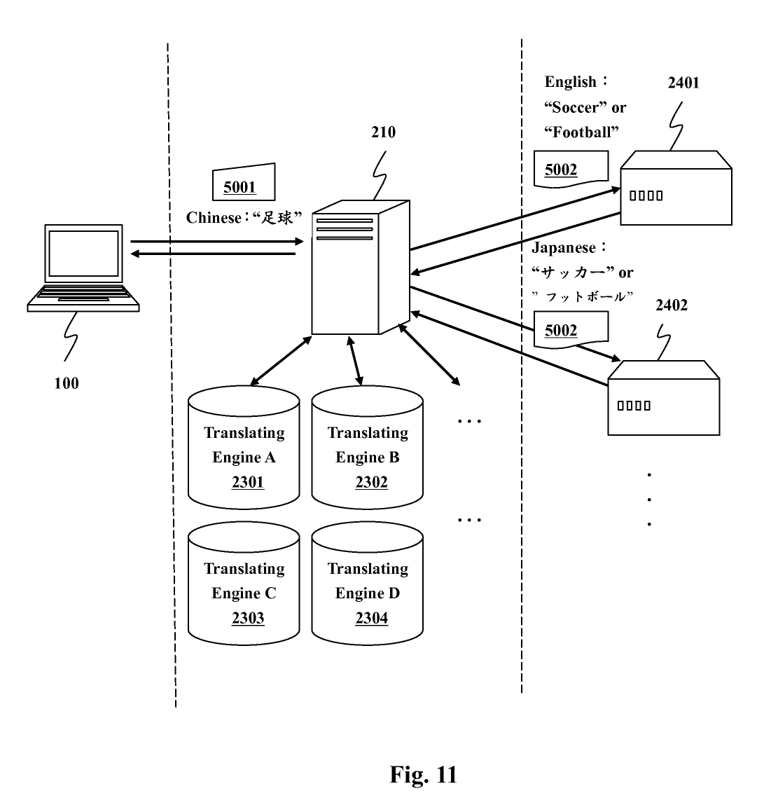

Please further refer to FIG. 9 to FIG. 12 for the second embodiment, where the networking searching system 20 in accordance with the second embodiment is similar to the networking searching system 20 in accordance with the first embodiment. Please refer to the description and the related figures in accordance with the first embodiment for more details. The difference of the networking searching system 20 between the first embodiment and the second embodiment is that the network searching system 20 of the second embodiment includes a plurality of translating engines such as a translating engine A 2301, a translating engine B 2302, a translating engine C 2303, a translating engine D 2304, and others and replaces the language database 220 with these translating engines. Therefore, please refer to FIG. 11 to FIG. 13, under the circumstance that the searching string 5001 received by the searching host 210 needs to be translated, the searching host 210 firstly receives the searching string 5001 entered in a first language such as searching string 5001 in Chinese: “ [symbol] ” (as shown in the step S1301) and recognizes a language type of the searching string 5001 such as Chinese (as shown in the step S1305), and the server 2401, the server 2402 separately support two language types, which are English and Japanese. The searching host 210 then sends the searching string 5001 in Chinese: “ [symbol] ” to the translating engine A 2301 and the translating engine B 2302 respectively. Both of the translating engines support translation from Chinese to English. The searching host 210 also sends the searching string 5001 in Chinese: “ [symbol] ” to the translating engine C 2303 and the translating engine D 2304, and both of the translating engines support translation from Chinese to Japanese. The translating engine A 2301, the translating engine B 2302, the translating engine C 2303, the translating engine D 2304, and others for translating the first language to other language types translate the searching string 5001: “ [symbol] ” (as shown in the step S1310) and separately generate a plurality of translating strings 5005 (as shown in the step S1315) in different language types.

After the searching host 210 receives the translating strings 5005 sent back from the translating engine A 2301, translating engine B 2302, translating engine C 2303, translating engine D 2304 and others respectively, the searching host 210 compares the translating strings 5005 in the same language type respectively and generates a plurality of language strings 5002 in different language types. For example, when the searching host 210 compares the translating strings 5005: “Soccer” or “Football” and “Soccer” sent respectively from the translating engine A 2301 and the translating engine B 2302, the simplest way for the searching host 210 to generate the corresponding language strings 5002 from the translating strings 5005 is to unify the translating strings 5005 a union: “Soccer” or “Football.” However, the way of comparison among the translating strings 5005 and the way of generating the corresponded language strings 5002 can be adjusted or changed and should not be limited to the embodiment set forth herein. The main object is to generate preferable language strings by comparison.

After the searching host 210 acquires the language strings 5002 corresponding to the searching string 5001 by the foregoing method, the search host 210 performs searching process for the merchandise information according to the language strings 5002, which is similar to the steps of searching the merchandise information with the language strings in accordance with the first embodiment. Therefore, the steps of searching the server 2401, the server 2402, and other servers in the searching host 210 corresponding to the language type according to the language strings 5002, the step of importing the merchandise information and the step of displaying the merchandise information matching the criterion of the language strings 5002 on the retrieval interface (as shown from the step S1330 to the step S1350) are similar to the steps from the step S1235 to the step S1255 shown in FIG. 3. Please refer to the step S1235 to the step S1255 and the related description of the first embodiment for more details.

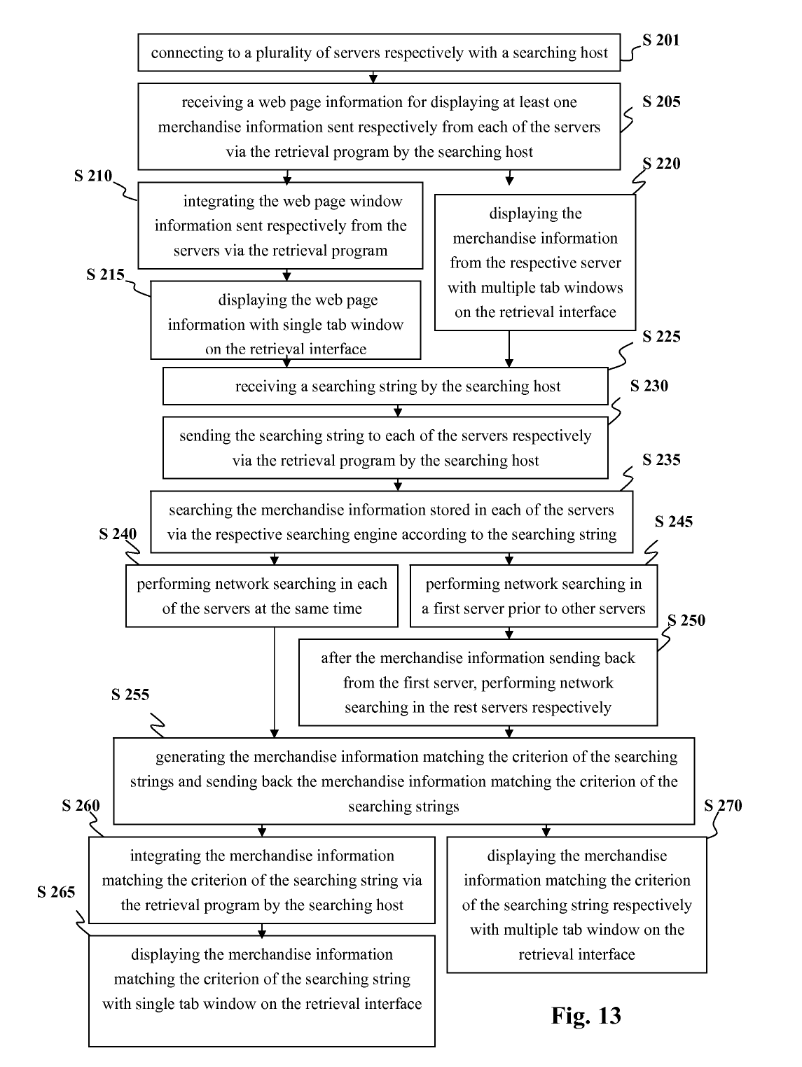

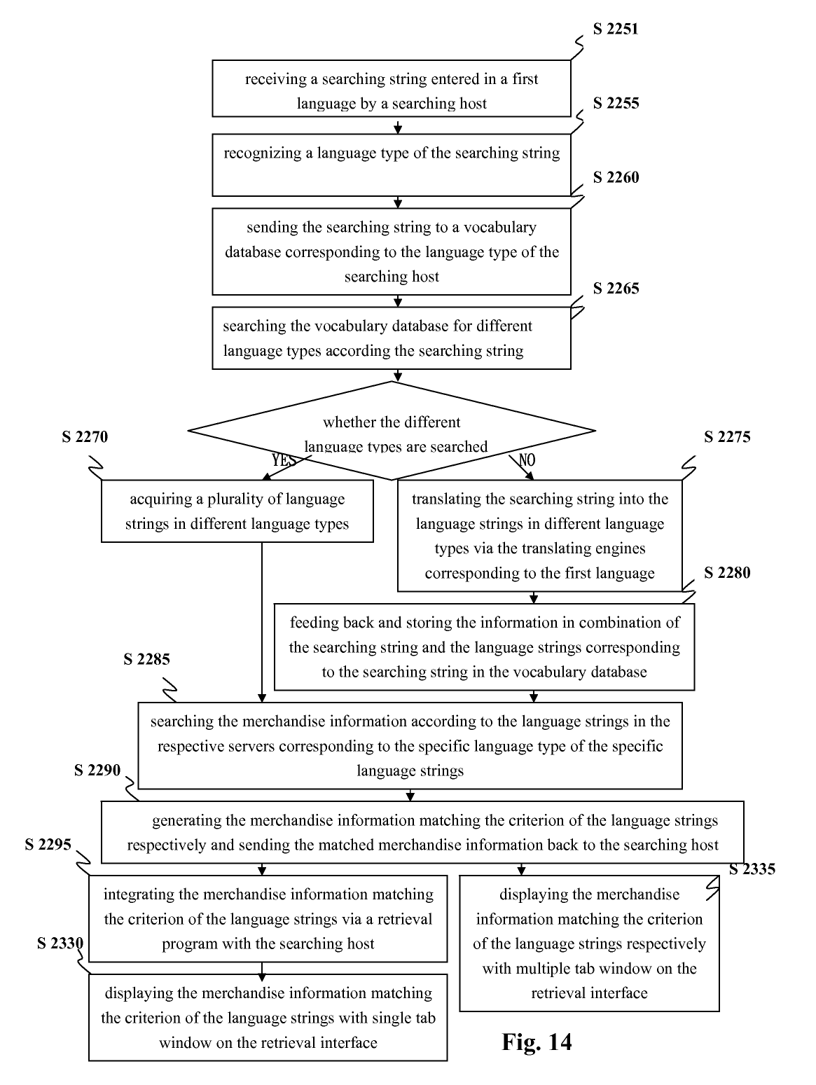

Please refer to FIG. 13 to FIG. 16 with continued reference to FIG. 1. In the third embodiment, the devices and the connection relation of the network searching system 20 in accordance with the third embodiment are similar to those in accordance with the first embodiment. The difference is that, in the third embodiment, the searching host 210 does not displays the merchandise information stored in the server 2401, the server 2402, and other servers; instead, the searching host 210 displays the merchandise information containing Hyper Links and embedded languages. The displaying way, however, should not be limited to the description described herein. Therefore, the network searching method in accordance with the third embodiment includes the steps, to be performed by the searching host 210, of: firstly, connecting to the sever 2401, the server 2402, and other servers respectively (as shown in the step S201); secondly, receiving the web page information displaying the merchandise information sent respectively from each of the servers via the retrieval program (as shown in the step S205); and displaying the web page information sent respectively from the server 2401, the sever 2402, and other servers on a retrieval interface. The displaying ways may include integrating and displaying the web page information with a single tab window (as shown in the step S210 and the step S215) or with multiple tab windows (as shown in the step S220). The details of the displaying ways can be referred to the description in accordance with the first embodiment. In addition, after the searching host 210 receives a searching string 5001 sent from the client computer 100 (as shown in the step S225), the searching host 210 sends the searching string 5001 to the server 2401, the server 2402, and others respectively via the retrieval program (as shown in the step S230). The server 2401, the server 2402, and others search the merchandise information stored in each of the servers via the respective searching engine according to the searching string 5001 (as shown in the step S235), generate the merchandise information matching the criterion of the searching string 5001, and sent the matched merchandise information back to the searching host (as shown in the step S255). In other words, in the third embodiment, instead of importing and storing all merchandise information from the server 2401, the serve 2402, and other servers, the searching host 210 displays the merchandise information sent respectively from the servers through Hyper Links and embedded languages on the retrieval interface 2401. In this way, the need of storage space for the searching host 210 can be greatly reduced. In addition, if the server(s) is (are) not permitted to provide downloading function of the merchandise information on its/their online shopping platform, the merchandise information is/are able to be displayed by the way in accordance with the third embodiment. Besides, the searching host 210 sends the searching string 5001 to each of the servers via the retrieval program so as to perform searching process in the respective servers. Hence, it is optionally to perform network searching in each of the servers at the same time (as shown in the step S240) or to perform network searching in a first server such as the server 2401 prior to other servers (as shown in the step S245). After the first server 2401 sends the merchandise information back to the searching host 210, other servers then perform the network searching (as shown in the step S250). With the latter process of searching in the first server firstly, the throughput of network searching can be reduced at first so as to increase the efficiency of network searching and to gain real-time searching result as quickly as possible. The searching processes according to the translated language strings 5002 are substantially the same as the searching processes mentioned above. In addition, in the third embodiment, the searching string 5001 is translated into language strings 5002 respectively via the vocabulary database 220 accompanied with translating engine 2301, translating engine 2302, and other translating engines. The detail translating mechanism is substantially the same as described in the first embodiment and can be referred to the description in accordance with the first embodiment.

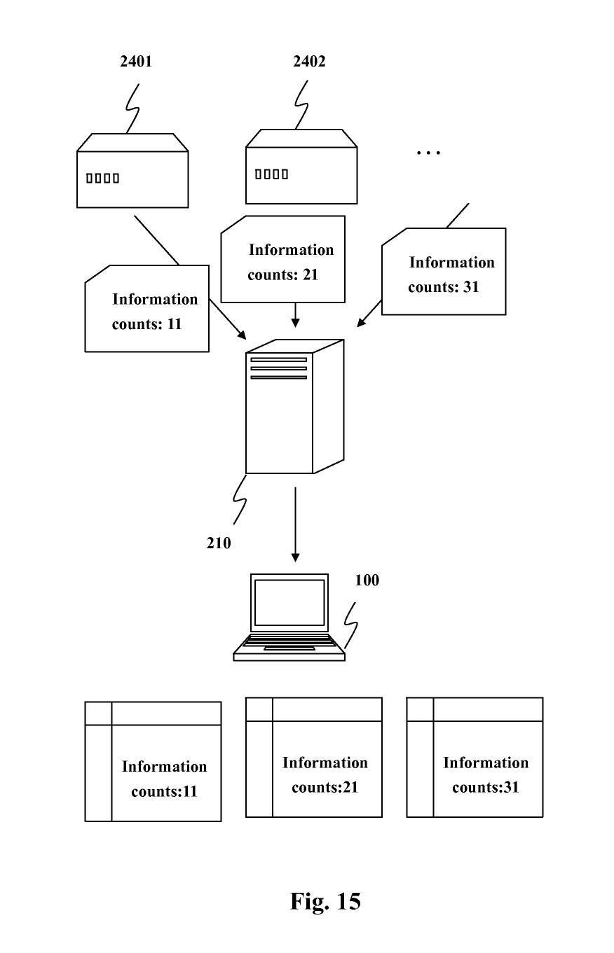

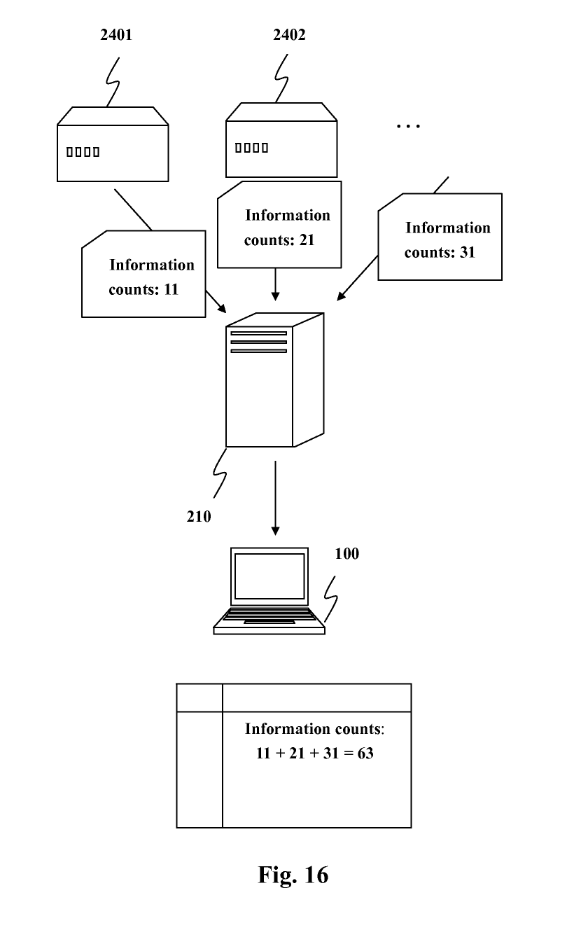

With the network searching method in accordance with the third embodiment, the searching host 210 is not responsible for providing storage space to store the merchandise information sent respectively from the server 2401, the server 2402, and other servers; instead, the searching host 210 displays the merchandise information containing by Hyper Links or embedded languages. Meanwhile, during the searching process, the searching host 210 is regarded as a medium for relaying and integrating, as shown in FIG. 15 and FIG. 16, and receives the matched results from the each of servers. Therefore, without being responsible for the storage space, the searching host 210 is able to integrate more merchandise information from each of the servers so as to provide various merchandise choices to users.

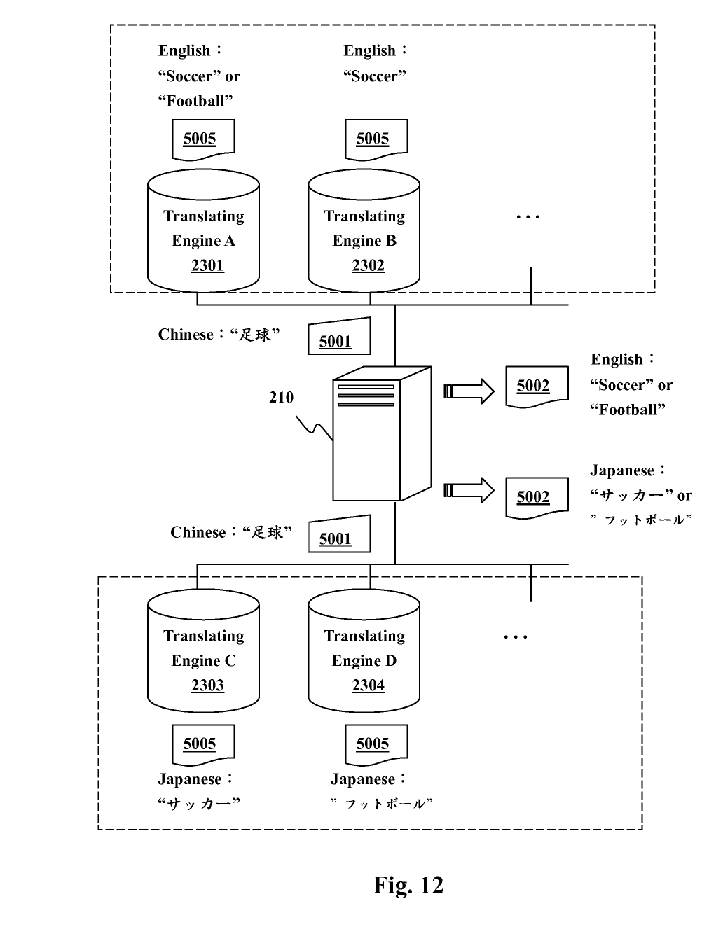

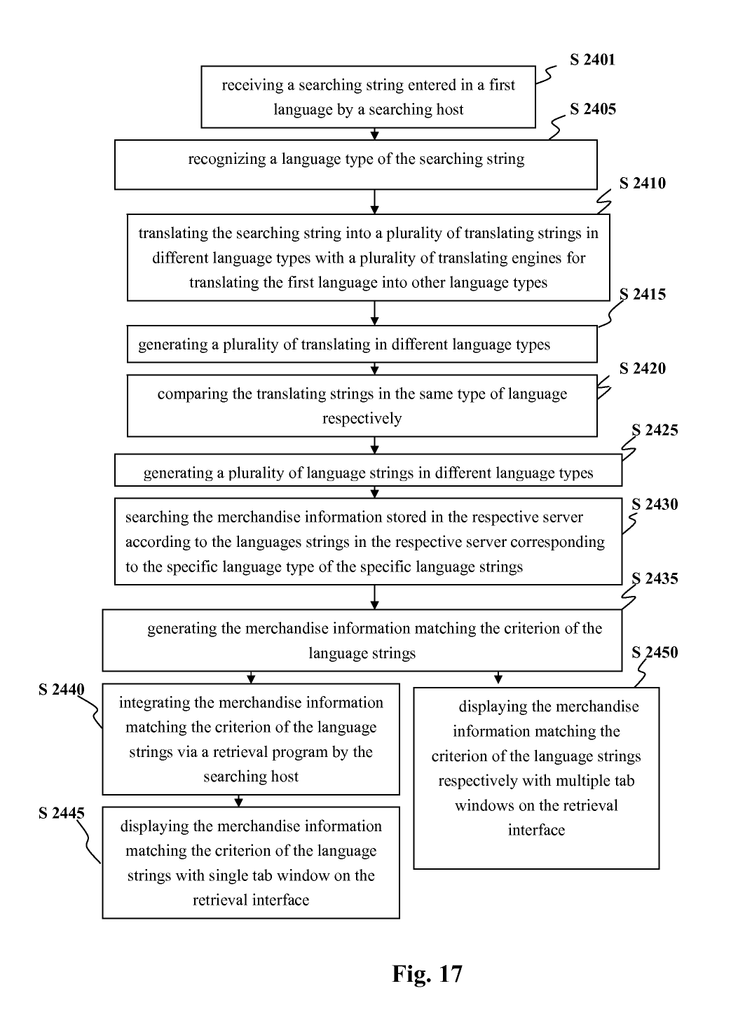

Please refer to FIG. 17 with continued reference to FIG. 9, FIG. 11, FIG. 12, FIG. 15 and FIG. 16 for the fourth embodiment, the network searching system 20 includes the translating engine A 2301, the translating engine B 2302, the translating engine C 2303, and the translating engine D 2304 disclosed in the second embodiment and replaces the vocabulary database 220 with the translating engine 2301, the translating engine 2302, and others. In addition, the merchandise information sent respectively from the server 2401, the server 2402, and other servers are displayed on the retrieval interface by using Hyper Links and embedded language as disclosed in the third embodiment. Please refer to the description and the related figures in accordance with the second embodiment and the third embodiment for more details.

Accordingly, a plurality of online shopping platforms of different countries can be used by using network connection or by importing the merchandise information to the network searching system, and the merchandise information may be displayed with a single tab window or with multiple tab windows for users to browse, search, or purchase merchandise. In addition, by using the two types of translating function specific to the merchandise information and searching string, users are able to enter searching string in their native language, and then the network searching system translates the searching string into the language strings corresponding to the searching string via the vocabulary database accompanied with translating engines or via multiple translating engines. Furthermore, users are able to search the merchandise information in the servers or the searching host suitable for different language types. In this way, users can sell or purchase merchandise through one network searching system for multiple online shopping platforms of different countries. Therefore, even though users are not good at other languages, they may still search the merchandise with the support of translating function by entering the language they are familiar with. Hence, the difficulties of using multinational online shopping platforms can be substantially reduced so as to increase the users' intention, and thus the business on multinational online shopping and online shopping for the users can be expanded.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope.

Accordingly, the scope of the present disclosure is defined by the appended claims rather than the foregoing description and the exemplary embodiments described therein.

What is claimed is:

1. A network searching system comprising:
a plurality of servers, each of the servers comprising a searching engine and storing at least one piece of merchandise information, and each of the servers searching the merchandise information via the corresponding searching engine; and
a searching host electrically connecting to each of the servers respectively and storing a retrieval program and a retrieval interface, the searching host importing the merchandise information from each of the servers respectively via the retrieval program and displaying the merchandise information on the retrieval interface,
wherein:
on receiving a searching string, the searching host searches the merchandise information imported from each of the servers according to the searching string via the retrieval program; the searching host generates the merchandise information matching the criterion of the searching string; and the searching host displays the merchandise information matching the criterion of the searching string on the retrieval interface.

2. The network searching system as claimed in claim 1, further comprising a vocabulary database storing a plurality of vocabulary information in different language types and corresponding to a first language,
wherein: the searching host receives the searching string in the first language, recognizes the language type of the searching string via the retrieval program and sends the searching string out; the vocabulary database receives the searching string, searches respectively for the vocabulary information in different language types according to the searching string and determines whether the vocabulary database stores a plurality of language strings in different language types for the searching string or not; wherein if the vocabulary database does, then the vocabulary database acquires the language strings and sends the language strings to the searching host; wherein if the vocabulary database does not, then the vocabulary database sends the searching string out; and
a plurality of translating engines supporting translation in different language types,
wherein:
the translating engines respectively receive the searching string, translate the searching string into the language strings in different language types, send the language strings to the searching host, feedback and store the information in combination of the searching string and the language strings corresponding to the searching string in the vocabulary database; and the searching host supports searching processes in different language types, searches the merchandise information imported respectively from the respective server according to the language strings corresponding to the specific language type of the searching host via the retrieval program, generates the merchandise information matching the criterion of the language strings and displays the merchandise information matching the criterion of the language strings on the retrieval interface.

3. The network searching system as claimed in claim 1, further comprising a plurality of translating engines supporting translation in different language types,
wherein:
the searching host receives the searching string in the first language, recognizes the language type of the searching string via the retrieval program and sends the searching string out; the translating engines respectively receive the searching string, translate the searching string into a plurality of language strings in different language types and send the language strings to the searching host; the searching host supports search processes in different language types; and the searching host searches the merchandise information imported respectively from each of the servers according to the language strings corresponding to the specific language type of the searching host, generates the merchandise information matching the criterion of the language strings and displays the merchandise information matching the criterion of the language strings on the retrieval interface.

4. The network searching system as claimed in claim 1, wherein the searching host integrates the merchandise information imported respectively from the servers via the retrieval program and displays the merchandise information with a single tab window on the retrieval interface, and the searching host integrates the merchandise information matching the criterion of the searching string via the retrieval program and displays the merchandise information matching the criterion of the searching string with single tab window on the retrieval interface.

5. The network searching system as claimed in claim 2, wherein the searching host integrates the merchandise information imported respectively from the servers via the retrieval program and displays the merchandise information with a single tab window on the retrieval interface, and the searching host integrates the merchandise information matching the criterion of the searching string via the retrieval program and displays the merchandise information matching the criterion of the searching string with single tab window on the retrieval interface.

6. The network searching system as claimed in claim 3, wherein the searching host integrates the merchandise information imported respectively from the servers via the retrieval program and displays the merchandise information with a single tab window on the retrieval interface, and the searching host integrates the merchandise information matching the criterion of the searching string via the retrieval program and displays the merchandise information matching the criterion of the searching string with single tab window on the retrieval interface.

7. The network searching system as claimed in claim 1, wherein the searching host imports the merchandise information respectively from the servers via the retrieval program and displays the merchandise information from each of the servers respectively with multiple tab windows on the retrieval interface, and the searching host generates the merchandise information matching the criterion of the searching string via the retrieval program and displays the merchandise information matching the criterion of the searching string respectively with multiple tab windows on the retrieval interface.

8. The network searching system as claimed in claim 2, wherein the searching host imports the merchandise information respectively from the servers via the retrieval program and displays the merchandise information from each of the servers respectively with multiple tab windows on the retrieval interface, and the searching host generates the merchandise information matching the criterion of the searching string via the retrieval program and displays the merchandise information matching the criterion of the searching string respectively with multiple tab windows on the retrieval interface.

9. The network searching system as claimed in claim 3, wherein the searching host imports the merchandise information respectively from the servers via the retrieval program and displays the merchandise information from each of the servers respectively with multiple tab windows on the retrieval interface, and the searching host generates the merchandise information matching the criterion of the searching string via the retrieval program and displays the merchandise information matching the criterion of the searching string respectively with multiple tab windows on the retrieval interface.

10. A network searching system, comprising:
a plurality of servers, each of the servers separately storing at least one piece of merchandise information and at least one piece of one web page information, each of the web page information being used for displaying the merchandise information stored in the respective server, and each of the servers comprising a searching engine and searching the merchandise information stored in the respective server via the searching engine; and
a searching host electrically connecting to each of the servers and storing a retrieval program and a retrieval interface, and the searching host connecting to each of the servers via the retrieval program and displaying the web page information respectively sent from each of the servers on the retrieval interface,
wherein:
the searching host receives a searching string and sends the searching string to each of the servers respectively via the retrieval program; each of the servers searches the merchandise information stored in the respective server according to the searching string via the searching engine, generates the merchandise information matching the criterion of the searching string and sends the merchandise information matching the criterion of the searching string back to the searching host; and the searching host receives the merchandise information matching the criterion of the searching string from each of the servers respectively and displays the merchandise information matching the criterion of the searching string on the retrieval interface.

11. The network searching system as claimed in claim 10, further comprising a vocabulary database storing a plurality of vocabulary information in different language types and corresponding to a first language,
wherein:
the searching host receives the searching string in the first language, recognizes the language type of the searching string via the retrieval program and sends the searching string out; and the vocabulary database receives the searching string, searches respectively for the vocabulary information in different language types according to the searching string and determines whether the vocabulary database stores a plurality of language strings in different language types for the searching string or not;
wherein if the vocabulary database does, then the vocabulary database acquires the language strings and sends the language strings to the searching host;
wherein if the vocabulary database does not, then the vocabulary database sends the searching string out; and
a plurality of translating engines supporting translation in different language types,
wherein:
the translating engines respectively receive the searching string, translate the searching string into language strings in different language types, send the language strings to the searching host, feedback and store the information in combination of the searching string and the language strings corresponding to the searching string in the vocabulary database; each of the searching engines in the respective server supports searching processes in different language types; and each of the servers receives the language strings sent respectively from the searching host, searches the merchandise information stored in the respective server according to the language strings corresponding to the specific language type of the respective server, generates the merchandise information matching the criterion of the language strings and sends the merchandise information matching the criterion of the language strings back to the searching host.

12. The network searching system as claimed in claim 10, further comprising a plurality of translating engines supporting translation in different language types,
wherein:
the searching host receives the searching string in the first language, recognizes the language type of the searching string via the retrieval program and sends the searching string out; the translating engines respectively receive the searching string, translate the searching string into a plurality of language strings in different language types, and send the language strings to the searching host; each searching engine of the respective server supports search processes in different language types; and each of the servers receives the language strings respectively sent from the searching host, searches the merchandise information stored in the servers according to the language strings corresponding to the specific language type of the respective server, generates the merchandise information matching the criterion of the language strings and sends the merchandise information matching the criterion of the language strings back to the searching host.

13. The network searching system as claimed in claim 10, wherein the searching host integrates the web page information sent from each of the servers via the retrieval program and displays the web page information with a single tab window on the retrieval interface, and the searching host integrates the merchandise information matching the criterion of the searching string sent back from each of the servers via the retrieval program and displays the merchandise information matching the criterion of the searching string with a single tab window on the retrieval interface.

14. The network searching system as claimed in claim 11, wherein the searching host integrates the web page information sent from each of the servers via the retrieval program and displays the web page information with a single tab window on the retrieval interface, and the searching host integrates the merchandise information matching the criterion of the searching string sent back from each of the servers via the retrieval program and displays the merchandise information matching the criterion of the searching string with a single tab window on the retrieval interface.

15. The network searching system as claimed in claim 12, wherein the searching host integrates the web page information sent from each of the servers via the retrieval program and displays the web page information with a single tab window on the retrieval interface, and the searching host integrates the merchandise information matching the criterion of the searching string sent back from each of the servers via the retrieval program and displays the merchandise information matching the criterion of the searching string with a single tab window on the retrieval interface.

16. The network searching system as claimed in claim 10, wherein the searching host receives the web page information respectively sent from each of the servers via the retrieval program and displays the web page information sent respectively from each of the servers with multiple tab windows on the retrieval interface, and the searching host receives the merchandise information matching the criterion of the searching string sent back from each of the servers via the retrieval program and displays the merchandise information matching the criterion of the searching string respectively with multiple tab windows on the retrieval interface.

17. The network searching system as claimed in claim 11, wherein the searching host receives the web page information respectively sent from each of the servers via the retrieval program and displays the web page information sent respectively from each of the servers with multiple tab windows on the retrieval interface, and the searching host receives the merchandise information matching the criterion of the searching string sent back from each of the servers via the retrieval program and displays the merchandise information matching the criterion of the searching string respectively with multiple tab windows on the retrieval interface.

18. The network searching system as claimed in claim 12, wherein the searching host receives the web page information respectively sent from each of the servers via the retrieval program and displays the web page information sent respectively from each of the servers with multiple tab windows on the retrieval interface, and the searching host receives the merchandise information matching the criterion of the searching string sent back from each of the servers via the retrieval program and displays the merchandise information matching the criterion of the searching string respectively with multiple tab windows on the retrieval interface.

19. A network searching method applicable to a network searching system, the method comprising the steps, to be performed by the searching host, of:
importing at least one piece of merchandise information stored in a plurality of servers respectively via a retrieval program;
displaying the merchandise information imported from each of the servers on a retrieval interface via the retrieval program;
receiving a searching string;
searching the merchandise information imported from each of the servers into the searching host according to the searching string via the retrieval program;
generating the merchandise information matching the criterion of the searching string; and
displaying the merchandise information matching the criterion of the searching string on the retrieval interface.

20. The network searching method as claimed in claim 19, wherein the step of receiving the searching string by the searching host further comprises the steps of:
receiving the searching string in a first language;
recognizing a language type of the searching string via the retrieval program and sending the searching string to a vocabulary database corresponding to the language type;
the vocabulary database searching for different language types according to the searching string and acquiring a plurality of language strings in different language types but not in the first language;
searching the merchandise information imported respectively from each of the servers according to the language strings in the searching host corresponding to the language type of the specific language strings;
generating the merchandise information matching the criterion of the language strings; and
displaying the merchandise information matching the criterion of the language strings on the retrieval interface via the retrieval program,
wherein:
if the vocabulary database is unable to acquire the language strings, then a plurality of translating engines corresponding to the first language respectively translate the searching string into the language strings in different language types but not in the first language, feedback and store the information in combination of the searching string and the language strings corresponding to the searching string into the vocabulary database.

21. The network searching method as claimed in claim 19, wherein the step of receiving the searching string by the search host further comprises the following steps of:
receiving the searching string in a first language;
recognizing a language type of the searching string ;
translating the searching string respectively with a plurality of translating engines translating the first language into other language types;
generating a plurality of translating strings in different language types;
comparing the translating strings in the same language types and generating a plurality of language strings in different language types;
searching the merchandise information imported from each of the servers according to the language strings in different language types in the searching host corresponding to the specific language type of the language strings;
generating the merchandise information matching the criterion of the language strings; and
displaying the merchandise information matching the criterion of the language strings via the retrieval program on the retrieval interface by the searching host.

22. The network searching method as claimed in claim 19, wherein in the step of displaying the merchandise information imported respectively from each of the servers via the retrieval program on the retrieval interface, the searching host integrates the merchandise information imported from the respective server via the retrieval program and displays the merchandise information with single tab window on the retrieval interface, and wherein in the step of displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

23. The network searching method as claimed in claim 20, wherein in the step of displaying the merchandise information imported respectively from each of the servers via the retrieval program on the retrieval interface, the searching host integrates the merchandise information imported from the respective server via the retrieval program and displays the merchandise information with single tab window on the retrieval interface, and wherein in the step of displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

24. The network searching method as claimed in claim 21, wherein in the step of displaying the merchandise information imported respectively from each of the servers via the retrieval program on the retrieval interface, the searching host integrates the merchandise information imported from the respective server via the retrieval program and displays the merchandise information with single tab window on the retrieval interface, and wherein in the step of displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

25. The network searching method as claimed in claim 19, wherein in the step of displaying the merchandise information imported from each of the servers via the retrieval program on the retrieval interface, the searching host imports the merchandise information from the servers respectively via the retrieval program and displays the merchandise information respectively from each of the servers with multiple tab windows on the retrieval interface, and wherein in the step of displaying the merchandise information matching the criterion of the searching string on the retrieval interface, the searching host generates the merchandise information matching the criterion of the searching string via the retrieval program and displays respectively the merchandise information matching the criterion of the searching string with multiple tab windows on the retrieval interface.

26. The network searching method as claimed in claim 20, wherein in the step of displaying the merchandise information imported from each of the servers via the retrieval program on the retrieval interface, the searching host imports the merchandise information from the servers respectively via the retrieval program and displays the merchandise information respectively from each of the servers with multiple tab windows on the retrieval interface, and wherein in the step of displaying the merchandise information matching the criterion of the searching string on the retrieval interface, the searching host generates the merchandise information matching the criterion of the searching string via the retrieval program and displays respectively the merchandise information matching the criterion of the searching string with multiple tab windows on the retrieval interface.

27. The network searching method as claimed in claim 21, wherein in the step of displaying the merchandise information imported from each of the servers via the retrieval program on the retrieval interface, the searching host imports the merchandise information from the servers respectively via the retrieval program and displays the merchandise information respectively from each of the servers with multiple tab windows on the retrieval interface, and wherein in the step of displaying the merchandise information matching the criterion of the searching string on the retrieval interface, the searching host generates the merchandise information matching the criterion of the searching string via the retrieval program and displays respectively the merchandise information matching the criterion of the searching string with multiple tab windows on the retrieval interface.

28. A network searching method applicable to a network searching system, the method comprising the steps, to be performed by the searching host, of:
connecting to a plurality of servers respectively via a retrieval program;
receiving a web page information displaying at least one merchandise information sent from each of the servers via the retrieval program and displaying the web page information sent from each of the servers on a retrieval interface;
receiving a searching string; sending the searching string to each of the servers respectively via the retrieval program; each of the servers searching the merchandise information stored in the respective server according to the searching string via the searching engine and generating the merchandise information matching the criterion of the searching string and sending the merchandise information matching the criterion of the searching string back to the searching host; and
receiving the merchandise information matching the criterion of the searching string from the servers respectively and displaying the merchandise information matching the criterion of the searching string on the retrieval interface.

29. The network searching method as claimed in claim 28, wherein the step of receiving the searching string by the searching host further comprises the steps of:
receiving the searching string in a first language;
recognizing a language type of the searching string via the retrieval program;
sending the searching string to a vocabulary database corresponding to the language type of the searching string;
the vocabulary database searching for different language types according the searching string and acquiring a plurality of the language strings in different language types, but not in the first language;
searching the merchandise information according to the language strings in each of the servers corresponding to the specific language type of the language strings respectively;
generating the merchandise information matching the criterion of the language strings respectively and sending the merchandise information matching the criterion of the language strings back to the searching host; and
receiving the merchandise information matching the criterion of the language strings and displaying the merchandise information matching the criterion of the language strings on the retrieval interface by the searching host respectively,
wherein:
if the vocabulary database is unable to acquire the language strings, then a plurality of translating engines corresponding to the first language translate the searching string into the language strings in different language types but not in the first language, feedback and store the information of the searching string and the language strings corresponding to the searching string in the vocabulary database.

30. The network searching method as claimed in claim 28, wherein the step of receiving the searching string by the searching host further comprises the steps of:
receiving the searching string in a first language;
recognizing the language type of the searching string;
translating the searching string with a plurality of translating engines translating the first language into other language types and generating a plurality of translating strings in different language types;
comparing the translating strings in the same language types respectively and generating a plurality of language strings in different language types;
searching the merchandise information stored in each of the servers according to the language strings in each of the servers corresponding to the specific language type of the specific language strings respectively, generating the merchandise information matching the criterion of the language strings and sending the merchandise information matching the criterion of the language strings back to the searching host respectively; and
receiving the searched merchandise information respectively and displaying the merchandise information matching the criterion of the language strings on the retrieval interface by the searching host.

31. The network searching method as claimed in claim 29, wherein the steps of searching the merchandise information stored in each of the servers according to the languages strings corresponding to the specific language type of the specific language strings respectively, generating the merchandise information matching the criterion of the language strings and sending the merchandise information matching the criterion of the language strings back to the searching host respectively are performed by each of the servers at the same time.

32. The network searching method as claimed in claim 29, wherein the steps of searching the merchandise information stored in each of the servers according to the languages strings corresponding to the specific language type of the specific language strings respectively and generating the merchandise information matching the criterion of the language strings and sending the merchandise information matching the criterion of the language strings back to the searching host respectively are the steps of searching the merchandise information according to the language strings in a first server of the servers and after the merchandise information is sent back from the first server, searching the rest servers respectively according to the language strings.

33. The network searching method as claimed in claim 28, wherein in the steps of receiving the web page information sent from each of the servers via the retrieval program and displaying the web page information sent from each of the servers on the retrieval interface by the searching host, the searching host integrates the merchandise information sent from the servers via the retrieval program and displays the merchandise information with a single tab window on the retrieval interface, and wherein in the steps of receiving the searched merchandise information respectively by the searching host and displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

34. The network searching method as claimed in claim 29, wherein in the steps of receiving the web page information sent from each of the servers via the retrieval program and displaying the web page information sent from each of the servers on the retrieval interface by the searching host, the searching host integrates the merchandise information sent from the servers via the retrieval program and displays the merchandise information with a single tab window on the retrieval interface, and wherein in the steps of receiving the searched merchandise information respectively by the searching host and displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

35. The network searching method as claimed in claim 30, wherein in the steps of receiving the web page information sent from each of the servers via the retrieval program and displaying the web page information sent from each of the servers on the retrieval interface by the searching host, the searching host integrates the merchandise information sent from the servers via the retrieval program and displays the merchandise information with a single tab window on the retrieval interface, and wherein in the steps of receiving the searched merchandise information respectively by the searching host and displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

36. The network searching method as claimed in claim 31, wherein in the steps of receiving the web page information sent from each of the servers via the retrieval program and displaying the web page information sent from each of the servers on the retrieval interface by the searching host, the searching host integrates the merchandise information sent from the servers via the retrieval program and displays the merchandise information with a single tab window on the retrieval interface, and wherein in the steps of receiving the searched merchandise information respectively by the searching host and displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

37. The network searching method as claimed in claim 32, wherein in the steps of receiving the web page information sent from each of the servers via the retrieval program and displaying the web page information sent from each of the servers on the retrieval interface by the searching host, the searching host integrates the merchandise information sent from the servers via the retrieval program and displays the merchandise information with a single tab window on the retrieval interface, and wherein in the steps of receiving the searched merchandise information respectively by the searching host and displaying the merchandise information matching the criterion of the searching string on the retrieval interface, the searching host integrates the merchandise information matching the criterion of the searching string via the retrieval program and displays the merchandise information matching the criterion of the searching string with a single tab window on the retrieval interface.

38. The network searching method as claimed in claim 28, wherein in the steps of receiving the web page information sent from each of the servers via the retrieval program and displaying the web page window information sent from each of the servers on the retrieval interface by the searching host, the searching host receives the merchandise information sent from the servers via the retrieval program and displays the merchandise information of each of the servers with multiple tab windows on the retrieval interface, and wherein in the steps of receiving the searched merchandise information respectively by the searching host and displaying the merchandise information matching the criterion of the searching string on the retrieval interface, the searching host generates the merchandise information matching the criterion of the searching string via the retrieval program and displays the merchandise information matching the criterion of the searching string with multiple tab windows on the retrieval interface.

39. The network searching method as claimed in claim 29, wherein in the steps of receiving the web page information sent from each of the servers via the retrieval program and displaying the web page window information sent from each of the servers on the retrieval interface by the searching host, the searching host receives the merchandise information sent from the servers via the retrieval program and displays the merchandise information of each of the servers with multiple tab windows on the retrieval interface, and wherein in the steps of receiving the searched merchandise information respectively by the searching host and displaying the merchandise information matching the criterion of the searching string on the retrieval interface, the searching host generates the merchandise information matching the criterion of the searching string via the retrieval program and displays the merchandise information matching the criterion of the searching string with multiple tab windows on the retrieval interface.

40. The network searching method as claimed in claim 30, wherein in the steps of receiving the web page information sent from each of the servers via the retrieval program and displaying the web page window information sent from each of the servers on the retrieval interface by the searching host, the searching host receives the merchandise information sent from the servers via the retrieval program and displays the merchandise information of each of the servers with multiple tab windows on the retrieval interface, and wherein in the steps of receiving the searched merchandise information respectively by the searching host and displaying the merchandise information matching the criterion of the searching string on the retrieval interface, the searching host generates the merchandise information matching the criterion of the searching string via the retrieval program and displays the merchandise information matching the criterion of the searching string with multiple tab windows on the retrieval interface.

41. The network searching method as claimed in claim 31, wherein in the steps of receiving the web page information sent from each of the servers via the retrieval program and displaying the web page window information sent from each of the servers on the retrieval interface by the searching host, the searching host receives the merchandise information sent from the servers via the retrieval program and displays the merchandise information of each of the servers with multiple tab windows on the retrieval interface, and wherein in the steps of receiving the searched merchandise information respectively by the searching host and displaying the merchandise information matching the criterion of the searching string on the retrieval interface, the searching host generates the merchandise information matching the criterion of the searching string via the retrieval program and displays the merchandise information matching the criterion of the searching string with multiple tab windows on the retrieval interface.

42. The network searching method as claimed in claim 32, wherein in the steps of receiving the web page information sent from each of the servers via the retrieval program and displaying the web page window information sent from each of the servers on the retrieval interface by the searching host, the searching host receives the merchandise information sent from the servers via the retrieval program and displays the merchandise information of each of the servers with multiple tab windows on the retrieval interface, and wherein in the steps of receiving the searched merchandise information respectively by the searching host and displaying the merchandise information matching the criterion of the searching string on the retrieval interface, the searching host generates the merchandise information matching the criterion of the searching string via the retrieval program and displays the merchandise information matching the criterion of the searching string with multiple tab windows on the retrieval interface.
